(19) United States
(12) Patent Application Publication
(10) Pub. No.: US 2024/0151572 A1
(43) Pub. Date: May 9, 2024

(54) NON-CONTACT LIQUID LEVEL SENSOR

(71) Applicant: ESS TECH, INC., Wilsonville, OR (US)

(72) Inventor: Joseph M. Cooley, Beaverton, OR (US)

(21) Appl. No.: 18/481,083

(22) Filed: Oct. 4, 2023

Related U.S. Application Data
(60) Provisional application No. 63/382,408, filed on Nov. 4, 2022.

(51) Int. Cl. G01F 23/28; G01F 23/284; G01F 23/2962; H01M 8/04082; H01M 8/04298; H01M 8/18

(52) U.S. Cl. CPC G01F 23/28; G01F 23/284; G01F 23/2962; H01M 8/04201; H01M 8/04298; H01M 8/188

(57) ABSTRACT

Systems and methods are provided for a non-contact level sensor system for a liquid tank. The non-contact level sensor system includes a non-contact level sensor positioned above a maximum level of liquid in the liquid tank, a float configured to float on a surface of the liquid and reflect and/or scatter energy emitted by the non-contact level sensor. The position of the float in a plane perpendicular to the energy emitted by the non-contact level sensor is confined within a housing, and the vertical distance between the float and the non-contact level sensor is related to an amount of liquid inside the liquid tank.

### CROSS REFERENCE TO RELATED APPLICATIONS

The present application claims priority to U.S. Provisional Application No. 63/382,408 entitled “NON-CONTACT LIQUID LEVEL SENSOR”, filed on Nov. 4, 2022. The entire contents of the above identified application is hereby included by reference for all purposes.

### FIELD

The present description relates generally to systems and methods for determining an amount of liquid within a tank.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. Installation, operation, and maintenance of a redox flow battery system may demand precise and accurate determination of an electrolyte amount (e.g., volume or level) in an electrolyte storage tank of the redox flow battery system. As one example, installation of a redox flow battery may include filling an electrolyte tank of the redox flow battery system to a desired volume with water to reach a desired electrolyte concentration.

An electrolyte tank may include a transparent graduated sight gauge by which an operator may view a liquid level within the electrolyte tank and thereby determine electrolyte volume. Additionally, the sight gauge may include one or more mechanical level switches which may be communicatively coupled to a controller of the redox flow battery system.

However, the inventors herein have recognized issues with the above system for measuring electrolyte volume. An operator reporting an electrolyte level based on the graduated sight gauge may be subject to human variation and error and may not be practically used for continuous monitoring of electrolyte levels. Mechanical level sensors may be used to report volumes at greater frequencies, but mechanical level sensors may come with limitation inherent in point sensors, including that an accuracy of the measurement may be dependent on the number of mechanical sensors used which may be limited by cost of the mechanical level sensors as well as an amount of available space. Additionally, mechanical level sensors may be prone to leaking and may degrade upon prolonged exposure to a high salt concentration of the electrolytes.

Non-contact level sensing may be used in place of visual sight gauges or mechanical level sensors. Non-contact level sensing may operate by emitting energy towards a liquid surface and receiving the energy reflected and/or scattered from the liquid surface. In this way a distance between the liquid surface and the non-contact level sensor can be determined and related to an amount of liquid within a tank. The non-contact level sensor may be advantageous based on its continuous operation and an absence of mechanical parts to be degraded by prolonged electrolyte contact. However, a surface of the electrolyte may be transparent to the energy emitted by the non-contact level sensor, allowing all energy emitted by the non-contact level sensor to pass through to the bottom of the tank instead of returning any energy to the sensor. Further, electrolyte may constantly flow into and out of the electrolyte tank during redox flow battery operation, causing turbulence at the electrolyte surface which may interfere with non-contact level sensors.

In one example, the issues described above may be at least partially addressed by a non-contact level sensor system for a liquid tank, comprising; a non-contact level sensor positioned above a maximum level of liquid in the liquid tank, a float configured to float on a surface of a liquid and reflect and/or scatter energy emitted by the non-contact level sensor, and wherein a position of the float in a plane perpendicular to the energy emitted by the non-contact level sensor is confined within a housing, and wherein a vertical distance between the float and the non-contact level sensor is related to an amount of liquid inside the liquid tank.

In this way, electrolyte amount may be determined automatically without relying on human judgement. Additionally, the electrolyte level may be monitored continuously which may help provide continuous feedback for optimizing performance of the redox flow battery system. Further, additional plumbing (e.g., sight gauges) used for detection of liquid levels may be simplified.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including an electrolyte tank with a non-contact level sensor.

FIG. 2 shows an illustration of an embodiment of an electrolyte tank including an external pipe including a non-contact level sensor.

FIG. 3 shows a closer view of the external pipe and non-contact level sensor of FIG. 2.

FIG. 4 shows an illustration of an alternate embodiment of the non-contact level sensor system, including an internal pipe.

FIG. 5 shows a flow chart of an example of a method for operating the non-contact level sensor system.

### DETAILED DESCRIPTION

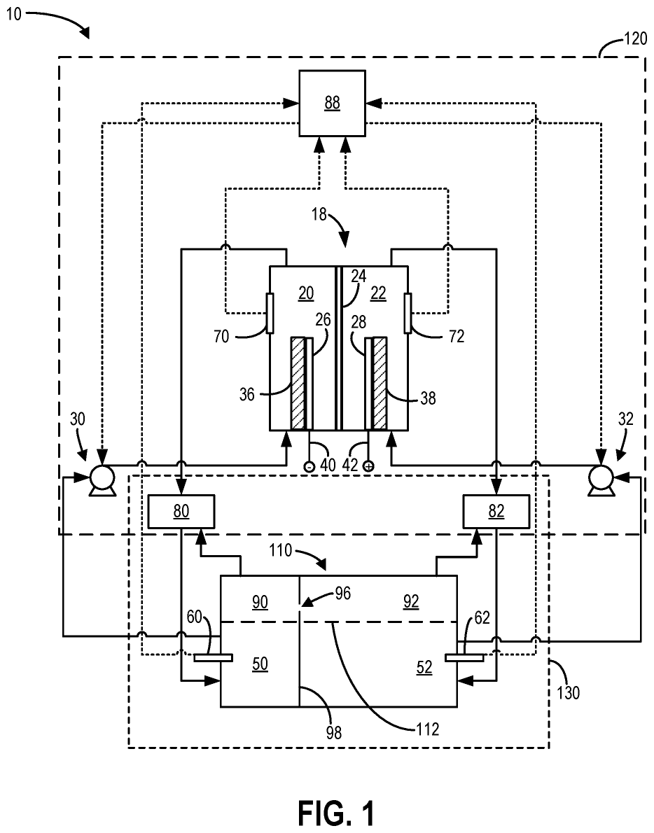

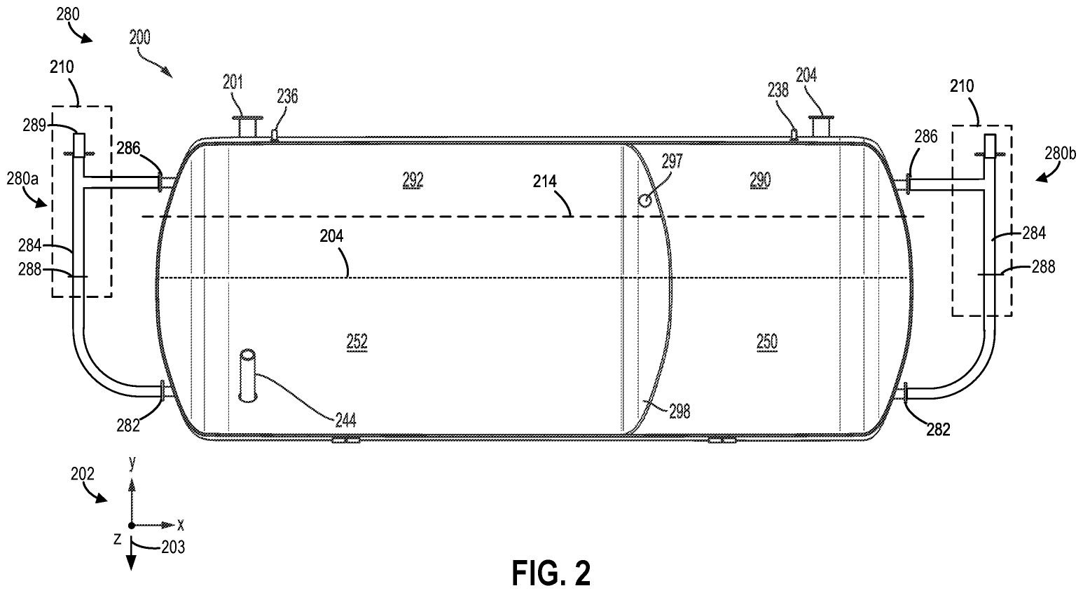

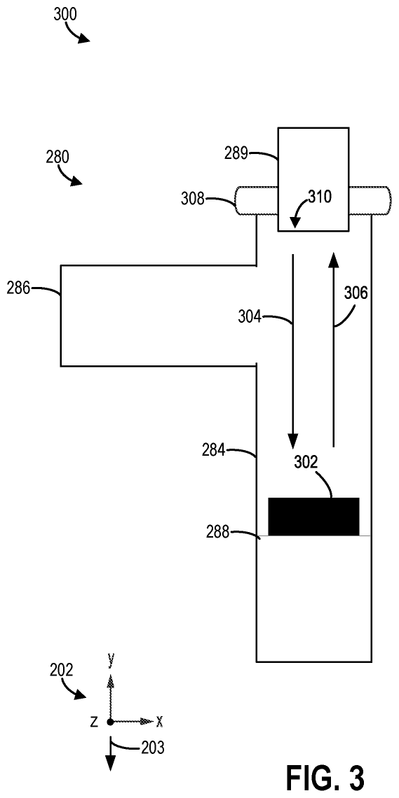

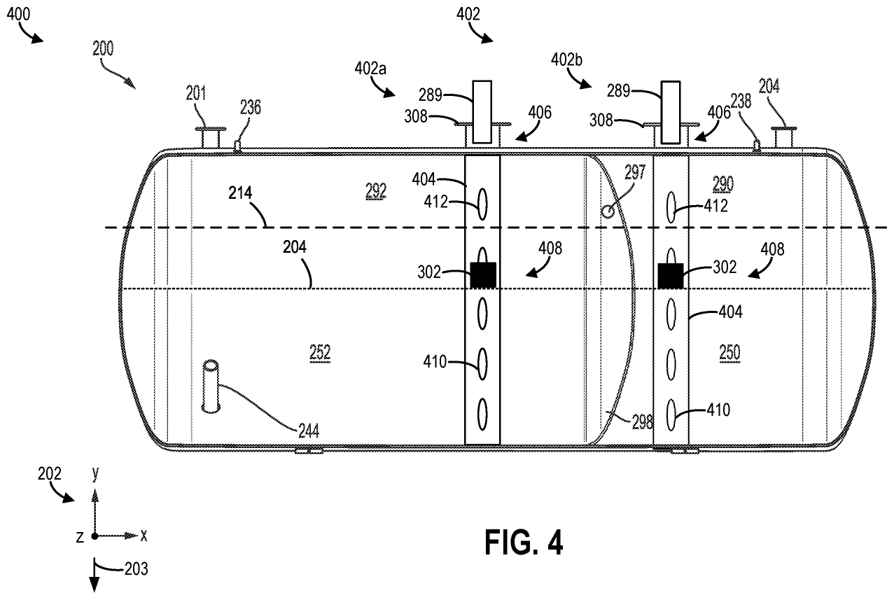

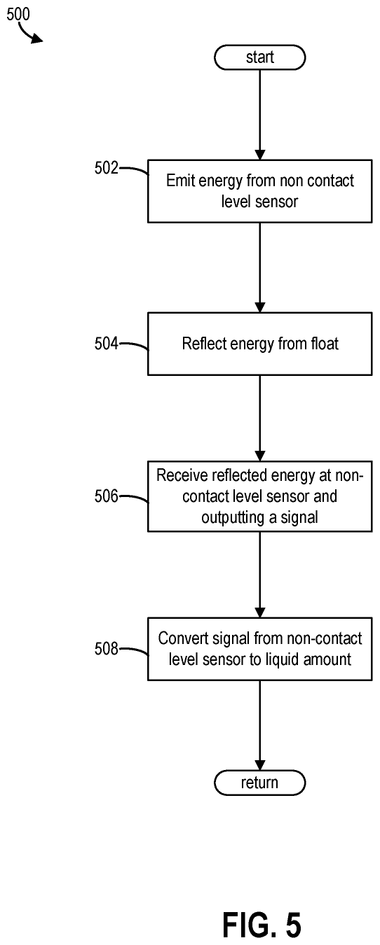

The following description relates to systems and method for a non-contact liquid level sensor. The non-contact level sensor system may be configured to detect an amount liquid within a liquid tank. As an exemplary embodiment, the liquid may be an electrolyte and the liquid tank may be an electrolyte chamber of a multi-chambered electrolyte storage tank of a redox flow battery system as shown in FIG. 1. However, the non-contact level sensor system may be configured to determine an amount of any liquid and may adapted to a desired tank configuration. An illustration of a first embodiment of a non-contact level sensor system coupled externally to a multi-chambered electrolyte storage tank is shown in FIG. 2. The non-contact level sensor system may include a housing, non-contact level sensor, and a float; details of which are shown in the detailed illustration of FIG. 3. In some situations, an alternate embodiment of the non-contact level sensor system wherein the housing is partially internal to the liquid tank may be desired. An illustration of the alternate embodiment of the non-contact level sensor system is shown in FIG. 4. An example of a method for operating the non-contact level sensor system is shown as a flow chart in FIG. 5.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V (negative electrode) (1)

2Fe²⁺↔2Fe³⁺+2e⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 may be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. More specifically, sensors 62 and 60 may be non-contact level sensor assemblies as described further below with respect to FIGS. 2-4. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 5 controller 88 may store a calibration curve or lookup table for determining electrolyte volumes based on a signal received from sensor 60 and/or sensor 62 in an example where sensor 60 and/or sensor 62 are non-contact level sensor assemblies. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Communication of electrolyte volumes to a controller of a redox flow battery system may be useful during installation, operation, and maintenance of the redox flow battery system. For this reason, an electrolyte level sensor which is fast, accurate, and precise as well as robust may be desired. Use of a graduated sight gauge to determine electrolyte volumes may be subject to human error and may not practically be used for continuous monitoring. Mechanical level sensors may be used continuously and without human error, but accuracy of mechanical level sensors may be limited to a number of sensors installed within an electrolyte tank and because the sensing is based on mechanical action, may be prone to degradation. Use of a non-contact level sensor assembly may enable continuous and accurate monitoring of electrolyte volume within an electrolyte tank. Further, the non-contact level sensor assembly may enable continuous and accurate monitoring of a liquid within a liquid tank. The challenges of using a non-contact level sensor including transparency and turbulence of the electrolyte or other liquid may be overcome by use of float confined within a housing to reflecting energy to a non-contact level sensor.

Referring now to FIG. 2, an example schematic of a multi-chambered electrolyte storage tank 200 including a non-contact level sensor assembly 280 is shown. Also shown in FIG. 2 is a coordinate system 202 including an x-axis, y-axis, and z-axis. The y-axis may be a vertical axis with respect to gravity. An arrow 203 indicates a direction of gravity. Multi-chambered electrolyte storage tank 200 may be similar to multi-chambered electrolyte storage tank 110 of FIG. 1. Multi-chambered electrolyte storage tank 200 is shown as a non-limiting example of a liquid tank which may incorporate at least one non-contact level sensor assembly 280. For example, non-contact level sensor assembly 280 may be included in a single chamber electrolyte tank or a tank holding a different liquid. In some embodiments, multi-chambered electrolyte storage tank 200 may include two non-contact level sensor assemblies 280, configured to sense a volume of electrolyte in each of a positive and a negative chamber of multi-chambered electrolyte storage tank 200 respectively. A first non-contact level sensor assembly 280a coupled to a first electrolyte chamber 252 may be the same as a second non-contact level sensor assembly 280b coupled to a second electrolyte chamber 250. First non-contact level sensor assembly 280a may include the same components as second non-contact level sensor assembly 280b and will be numbered the same and discussed together as non-contact level sensor assembly 280.

Multi-chambered electrolyte storage tank 200 may be internally divided into the first electrolyte chamber 252 and the second electrolyte chamber 250. In the example of FIG. 1, the first electrolyte chamber 252 and the second electrolyte chamber 250 correspond to the positive electrolyte chamber 52 and the negative electrolyte chamber 50, respectively. As one example, a line 204 may indicate a liquid level within multi-chambered electrolyte storage tank 200. First gas head space 292 and second gas head space 290 may comprise volumes inside multi-chambered electrolyte storage tank 200 and above line 204 in first electrolyte chamber 252 and second electrolyte chamber 250 respectively. Bulkhead 298 may fluidly separate and decouple the first electrolyte chamber 252 and second electrolyte chamber 250, except at a spill-over hole 297. Spill-over hole 297 creates an opening in the bulkhead 298 for equilibrating gas pressures and compositions between the first and second electrolyte chambers 252 and 250.

Multi-chambered electrolyte storage tank 200 may further include one or more gas outlet ports 236 and 238 positioned towards an upper surface from each of the first electrolyte chamber 252 and second electrolyte chamber 250, respectively. The gas outlet ports 236 and 238 may be fluidly coupled to and positioned above gas head spaces 292 and 290, respectively, facilitating supply of hydrogen gas from the integrated multi-chambered electrolyte storage tank to a rebalancing reactor such as rebalancing reactors 80 and 82 of FIG. 1, or receiving hydrogen gas from an external hydrogen gas source. Additionally, one or more liquid outlets 244 (liquid outlet at second electrolyte chamber 250 that may not be visible due to perspective of cross-sectional cutaway) from each of the first and second electrolyte chambers may be used to supply electrolyte to a flow battery cell (e.g., flow battery cell 18 of FIG. 1) and/or rebalancing reactors. Electrolyte may be returned from the one or more redox flow battery cells to the first and second electrolyte chambers 250 and 252 by way of first and second electrolyte return pipes 201 and 204 oriented more vertically with respect to gravity (e.g., more parallel to the y-axis) within the integrated multi-chambered electrolyte storage tank 200. In FIG. 2, the y-axis is parallel with gravity (where gravity generates a downward force toward the bottom of the figure as indicated by arrow 203).

Non-contact level sensor assembly 280 may be external to multi-chambered electrolyte storage tank 200. Non-contact level sensor assembly 280 may include a housing 284 configured to fill with electrolyte to a level indicated by line 288 which is equal or directly proportional to the level of electrolyte within the electrolyte chamber to which non-contact level sensor assembly 280 is coupled. A bottom end of housing 284 may be coupled to a lower portion (e.g., lower along the y-axis) of multi-chambered electrolyte storage tank 200. The bottom end of housing 284 may terminate at a liquid port 282, fluidly coupling a housing 284 of non-contact level sensor assembly 280 the liquid tank (e.g., to first electrolyte chamber 252 and/or second electrolyte chamber 250 in this example). Liquid port 282 may couple to multi-chambered electrolyte storage tank 200 at a lower (e.g., along the y-axis) portion of a sidewall of multi-chambered electrolyte storage tank 200. A lower threshold of a sensing range of non-contact level sensor assembly 280 may be determined by a position of liquid port 282. Liquid port 282 may be positioned below a minimum electrolyte level. For example, liquid port 282 may be positions between 200 mm and 1170 cm from a bottom of multi-chambered electrolyte storage tank 200. In this way, a non-contact level sensor assembly may measure a full range of electrolyte levels within multi-chambered electrolyte storage tank 200. Additionally, liquid port 282, positioned below the minimum electrolyte level, may also be used as a drain for the electrolyte chamber to which the liquid port is coupled. In one embodiment liquid port 282 may be three-way port and flow through liquid port 282 may be controlled by a three-way valve. In a first positon, the three-way valve may fluidly couple non-contact level sensor assembly 280 with the electrolyte chamber. In a second position, the three valve may fluidly couple the electrolyte chamber to a drain.

Additionally, housing 284 of non-contact level sensor assembly 280 may include a gas port 286 fluidly coupling housing 284 to first gas head space 292 or second gas head space 292. Gas port 286 may be positioned at an upper (e.g., along the y-axis) portion of the sidewall of multi-chambered electrolyte storage tank 200. As one example gas port 286 may be positioned above a maximum liquid level indicated by dashed line 214. In this way, electrolyte entering housing 284 through liquid port 282 may be subject to the same gas pressure as electrolyte within multi-chambered electrolyte storage tank 200. For this reason, a vertical level of electrolyte within housing 284, as indicated by line 288 may equal the vertical level of electrolyte within multi-chambered electrolyte tank as indicated by line 204.

Non-contact level sensor assembly 280 may further include a non-contact level sensor 289 positioned at a top end of housing 284. Top end of housing 284 may be positioned at a vertical level above gas port 286. Further details of non-contact level sensor 289 and non-contact level sensor assembly 280 may be discussed further with respect to FIG. 3. FIG. 3 shows a portion of non-contact level sensor assembly 280 as outlined by box 210.

Turning now to FIG. 3, view 300 shows a portion of non-contact level sensor assembly 280 within box 210 as shown in FIG. 2. As shown in greater detail, non-contact level sensor 289 may be coupled to the top of housing 284 by a flange 308. In one embodiment, flange 308 may circumferentially surround non-contact level sensor 289 and may hermetically seal non-contact level sensor 289 at a top of housing 284. In this way, gas from the gas head space to which housing 284 is coupled may be forced to enter and exit housing 284 through gas port 286 and a pressure equilibrium between non-contact level sensor assembly 280 and gas head space 290 and gas head space 292 may be maintained. In such an embodiment, an end 310 of non-contact level sensor 289 through which energy is emitted and received may be positioned inside housing 284. In an alternate embodiment, flange 308 may circumferentially surround a cap configured to hermetically seal the top (e.g., top with respect to direction of gravity) of housing 284. The cap may include a window transparent to the energy emitted and received by non-contact level sensor 289. In such an embodiment, the end 310 of non-contact level sensor 289 may be positioned in face sharing contact with a top surface of the window. In this way, non-contact level sensor 289 may probe a level of liquid within the housing without being exposed to gas within the liquid tank (e.g., such as the gas in gas head spaces of multi-chambered electrolyte storage tank 200).

Non-contact level sensor 289 may be configured to emit energy toward a surface of electrolyte within housing 284 in a direction indicated by arrow 304. In some embodiments, the energy may be in a form of acoustic waves (e.g., an ultrasonic sensor), microwaves (e.g., a radar sensor), or coherent light (e.g., a lidar sensor), among others. Energy emitted by non-contact level sensor 289 may interact with a float 302 configured to float on a top surface of electrolyte within housing 284 (e.g., due to buoyancy). A top surface of float 302 may be configured to reflect and/or scatter the energy emitted by non-contact level sensor 289 back towards non-contact level sensor 289 in a direction indicated by arrow 306. Said another way, the top surface of float 302 may be configured to be opaque and/or reflective (e.g., non-transparent) to the energy emitted by non-contact level sensor 289. In one embodiment the float may be formed of a material that is opaque and/or reflective to the energy emitted by non-contact level sensor 289, or least more reflective than the top surface of the liquid electrolyte. In an alternate embodiment, the top surface of float 302 may be coated with a material configured to be opaque and/or reflective to the energy emitted by non-contact level sensor 289 and float 302 may be made of a different material. In this way, energy may be directed back towards non-contact level sensor 289 even if the electrolyte or other liquid within housing 284 is transparent to or absorbs the energy emitted by non-contact level sensor 289. Additionally, the top surface of float 302 may be approximately flat in the x-z plane perpendicular to the direction of energy emitted by non-contact level sensor 289.

Float 302 may be configured to float on a top surface of the electrolyte. Float 302 may move vertically within an inner volume of housing 284 according to a level of electrolyte within housing 284 and thereby according to the amount of electrolyte within the electrolyte chamber to which housing 284 is fluidly coupled. Dimensions of float 302 in the plane perpendicular to the energy emitted by non-contact level sensor 289 (e.g., the x-z plane) may be smaller than an inner diameter of housing 284. In this way, float 302 may move vertically within housing 284 and may maintain a position floating on the top surface of electrolyte within housing 284 as the level (e.g., vertical height) of electrolyte within housing 284 increases and decreases. Additionally, the dimensions of float 302 in the plane perpendicular to the energy emitted by non-contact level sensor 289 may be large enough that the top surface of float 302 may not move to a position within housing 284 where energy emitted by non-contact level sensor 289 interacts with a surface of the electrolyte and not the top surface of float 302. As one example, housing 284 may be shaped as tube and float 302 may be shaped as a disc (e.g., like a shape of a hockey puck). However, other shapes of housing 284 and float 302 have been considered within a scope of the disclosure.

Non-contact level sensor 289 may be communicatively coupled to a controller such as controller 88 of redox flow battery system 10 as described above with respect to FIG. 1. Upon receiving the returned energy, non-contact level sensor 289 may output a signal related to a level (e.g., height along the y-axis) of electrolyte within housing 284 which may be proportional the amount of electrolyte in the electrolyte chamber to which housing 284 is fluidly coupled. The controller may store a calibration for converting the signal output by non-contact level sensor 289 to an amount of electrolyte within an electrolyte chamber to which the non-contact level sensor assembly 280 is fluidly coupled (e.g., first and second electrolyte chambers 250 and 252).

Turning now to FIG. 4, a view 400 of an alternate embodiment of a non-contact level sensor assembly 402 is shown. Non-contact level sensor assembly 402 may include a housing 404. Additional components of non-contact level sensor assembly 402 may include a float 302 and a non-contact level sensor 289 as well as components which are discussed with respect to non-contact level sensor assembly 280 of FIGS. 2-3. Such components are labeled similarly and will not be reintroduced. Non-contact level sensor assembly 402 is shown in view 400 included in multi-chambered electrolyte storage tank 200 as one embodiment. Non-contact level sensor assembly 402 may be included in other electrolyte tank configurations without departing from a scope of the disclosure. Additionally, multi-chambered electrolyte storage tank may include a first non-contact level sensor assembly 402a and a second non-contact level sensor assembly 402b which may be the same and include the same components. First non-contact level sensor assembly 402a and second non-contact level sensor assembly 402b are discussed together below as non-contact level sensor assembly 402.

Housing 404 may be formed as a perforated pipe and may be herein referred to perforated pipe 404. Perforated pipe 404 may pass through a top wall of multi-chambered electrolyte storage tank 200 and may be partially internal to multi-chambered electrolyte storage tank 200. The top wall of multi-chambered electrolyte storage tank 200 may divide perforated pipe 404 into an upper portion 406 positioned outside of multi-chambered electrolyte storage tank 200 and a lower portion 408 positioned within a chamber of multi-chambered electrolyte storage tank 200. A portion of the top wall of multi-chambered electrolyte storage tank 200 surrounded by walls of perforated pipe 404 may be absent. In this way, energy emitted by non-contact level sensor 289 may pass from the upper portion 406 to the lower portion 408 without being blocked or absorbed by the top wall of multi-chambered electrolyte storage tank 200. Walls of upper portion 406 may be unbroken and not perforated. A top of upper portion 406 may be coupled to flange 308 and non-contact level sensor 289 as described above with respect to FIG. 3.

Lower portion 408 may extend vertically (e.g., along the y-axis) from a top surface of multi-chambered electrolyte storage tank 200 to a bottom surface of multi-chambered electrolyte storage tank 200. A bottom end of lower portion 408 may be in face sharing contact with the bottom surface of multi-chambered electrolyte storage tank 200. In this way perforated pipe 404 may be supported and high stress at a point of interface between upper portion 406 and lower portion 408 may be avoided. Lower portion 408 may include a plurality of perforations 410 positioned between a bottom of perforated pipe 404 and maximum electrolyte level 214. In some examples, perforations may be present between the bottom of perforated pipe 404 and the bottom of multi-chambered electrolyte storage tank 200. In this way, trapping of any solids present in the electrolyte within perforated pipe 404 may be minimized. Perforations 410 may be sized to allow electrolyte to freely pass through but may be smaller in width (e.g., in the x-z plane) than float 302, thereby keeping float 302 within the walls of perforated pipe 404. In this way perforated pipe 404 may be fluidly coupled with electrolyte of first electrolyte chamber 252 and second electrolyte chamber 250. Perforations 410 may be oval, circular, rectangular, among other shapes. At least one gas perforation 412 may be included in lower portion 408 and positioned above maximum electrolyte level 214. Gas perforation 412 may fluidly couple perforated pipe 404 with gas head space 290 and gas head space 292 respectively. Gas perforation 412 may be shaped similarly to perforations 410. Gas perforation 412 may allow electrolyte within perforated pipe 404 to experience the same gas pressure as electrolyte in the rest of multi-chambered electrolyte storage tank 200. In this way, a vertical height of electrolyte within perforated pipe 404 may be the same as a vertical height of electrolyte within the electrolyte chamber to which perforate pipe 404 is fluidly coupled.

Turning now to FIG. 5, an example of a method 500 for operating at least one non-contact level sensor system such as non-contact level sensor assembly 280 of FIG. 2-3 or 402 of FIG. 4 is shown. At least one non-contact level sensor system may be fluidly coupled to a liquid tank. In one embodiment, the liquid tank may be a chamber of multi-chambered electrolyte storage tank 110 of FIG. 1 or 200 of FIGS. 2 and 4 of a redox flow battery system (e.g., redox flow battery system 10 of FIG. 1). Method 500 may be at least partially carried out via the controller 88 of FIG. 1 and may be stored as executable instructions at a non-transitory storage medium (e.g., memory) communicably coupled to controller 88. Method 500 may be executed upon activation of the redox flow battery system.

At 502, method 500 includes emitting energy from a non-contact level sensor of the non-contact level sensor assembly. The energy may be in a form of acoustic waves or microwave radiation, among others, as described above with respect to FIG. 3. The non-contact level sensor may be positioned so that the energy when emitted is directed towards a liquid surface within a housing, such as housing 284 of FIG. 2 or perforated pipe 404 of FIG. 4. As one example, the liquid may be an electrolyte.

At 504, method 500 includes reflecting and/or scattering energy from a float, such as float 302 of FIG. 3, which may be floating on the liquid surface within the housing. The reflected energy may be directed back towards the non-contact level sensor which from which the energy was emitted.

At 506, method 500 includes receiving the reflected and/or scattered energy at the non-contact level sensor and outputting a signal. The signal may be formed based on characteristics of the emitted and received energy. As a non-limiting example, the signal may be based on an elapsed time between emission of the energy and receiving the reflected energy. The signal may be related to a distance between the non-contact level sensor and the float which may be inversely proportion to a vertical height of electrolyte within the standpipe or the perforated pipe. In one example, the signal may be averaged over a period of time. In this way, fluctuations of the signal due to electrolyte turbulence may be smoothed.

At 508, method 500 includes converting the signal from the non-contact level sensor to a liquid amount within the liquid tank to which the non-contact level sensor system is fluidly coupled. As one embodiment, the liquid amount may be an electrolyte volume within an electrolyte chamber fluidly coupled to the non-contact level sensor system. In one embodiment, the signal may be output to a controller of redox flow battery system (e.g., controller 88 of FIG. 1) which may include instructions (e.g., a calibration or lookup table) for converting the signal to an amount of electrolyte. In another example, the non-contact level sensor may include instructions for converting the signal to the electrolyte volume and the electrolyte amount may be output to the controller of the redox flow battery system. In response to the converted signal, the controller of the redox flow battery system may adjust operation of the redox flow battery system. For example, if the converted signal corresponds to a volume of electrolyte below an electrolyte threshold level stored on the controller redox flow battery system, the control of the redox flow battery system may set an operation mode of the redox flow battery system to stand by. Method 500 returns. As one example, method 500 may repeat at a frequency of one sample per second and continuously monitor volume of electrolyte in the electrolyte tank during operation of the redox flow battery system.

The technical effect of method 500 is that an amount of liquid within a liquid tank may be continuously and precisely output to a controller of a redox flow battery by a non-contact level sensor system, even if the liquid is transparent to or absorbent of energy emitted by the non-contact level sensor. The non-contact level sensor system may operate without demanding human judgement. Additionally, the float of the non-contact level sensor system may reliably reflect energy emitted by the non-contact level sensor regardless of the relative transparency or turbulence of the electrolyte on which it floats. A housing of the non-contact level sensor system may additionally aid in shielding the float from turbulence in the liquid tank. Further, the non-contact level sensor system may avoid use of mechanical components in contact with electrolytes or other harsh liquids and may therefore be robust and demand less maintenance than mechanical switches which may corrode or accumulate salts.

The disclosure also provides support for a non-contact level sensor assembly for a liquid tank, comprising: a non-contact level sensor positioned above a maximum level of liquid in the liquid tank, a float configured to float on a surface of the liquid and reflect and/or scatter energy emitted by the non-contact level sensor, and, wherein a position of the float in a plane perpendicular to the energy emitted by the non-contact level sensor is confined within a housing, and wherein a vertical distance between the float and the non-contact level sensor is related to an amount of liquid inside the liquid tank. In a first example of the system, the liquid is transparent to the energy emitted by the non-contact level sensor. In a second example of the system, optionally including the first example, the housing is fluidly coupled to the liquid tank. In a third example of the system, optionally including one or both of the first and second examples, the housing is external to the liquid tank. In a fourth example of the system, optionally including one or more or each of the first through third examples, the housing is partially internal to the liquid tank. In a fifth example of the system, optionally including one or more or each of the first through fourth examples, a top of the housing with respect to gravity is hermetically sealed. In a sixth example of the system, optionally including one or more or each of the first through fifth examples, the liquid tank is an electrolyte tank a redox flow battery system.

The disclosure also provides support for a method, comprising: emitting energy from a non-contact level sensor of a non-contact level sensor system towards a float of the non-contact level sensor system, the non-contact level sensor system fluidly coupled to a liquid tank, reflecting and/or scattering energy from the float towards the non-contact level sensor, receiving the reflected and/or scattered energy at the non-contact level sensor and outputting a signal, and converting the signal to a liquid amount inside the liquid tank. In a first example of the method, the liquid tank is an electrolyte tank of a redox flow battery system. In a second example of the method, optionally including the first example, the method further comprises: adjusting the redox flow battery system in response to the converted signal. In a third example of the method, optionally including one or both of the first and second examples, emitting the energy includes emitting acoustic waves or microwaves. In a fourth example of the method, optionally including one or more or each of the first through third examples, the float is positioned within a housing of the non-contact level sensor system. In a fifth example of the method, optionally including one or more or each of the first through fourth examples, the method further comprises: averaging the signal for a period of time before outputting the signal. In a sixth example of the method, optionally including one or more or each of the first through fifth examples, the method is repeated continuously during operation of a redox flow battery system.

The disclosure also provides support for a redox flow battery system, comprising: an electrolyte tank an electrolyte filling the electrolyte tank to an electrolyte level, a gas head space within the electrolyte tank including a volume of the electrolyte tank above the electrolyte level, at least one non-contact level sensor system including a housing fluidly coupled to the electrolyte tank, and wherein the at least one non-contact level sensor system includes a float and a non-contact level sensor. In a first example of the system, the float is floating on a surface of the electrolyte. In a second example of the system, optionally including the first example, a gas pressure within the housing fluidly coupled to electrolyte chamber is equal to a gas pressure within the electrolyte tank. In a third example of the system, optionally including one or both of the first and second examples, the float is formed of a material opaque and/or reflective to an energy emitted by the non-contact level sensor or a top of the float is coated with the material opaque and/or reflective to the energy emitted by the non-contact level sensor. In a fourth example of the system, optionally including one or more or each of the first through third examples, the electrolyte tank is a multi-chambered electrolyte storage tank. In a fifth example of the system, optionally including one or more or each of the first through fourth examples, the at least one non-contact level sensor system includes a first non-contact level sensor assembly configured to output an amount of electrolyte in a first electrolyte chamber of the multi-chambered electrolyte storage tank and a second non-contact level sensor assembly configured to output an amount of electrolyte in a second electrolyte chamber of the multi-chambered electrolyte storage tank.

FIGS. 2-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-4 are drawn approximately to scale, although other dimensions or relative dimensions may be used.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A non-contact level sensor assembly for a liquid tank, comprising:
a non-contact level sensor positioned above a maximum level of liquid in the liquid tank;
a float configured to float on a surface of the liquid and reflect and/or scatter energy emitted by the non-contact level sensor; and
wherein a position of the float in a plane perpendicular to the energy emitted by the non-contact level sensor is confined within a housing, and wherein a vertical distance between the float and the non-contact level sensor is related to an amount of liquid inside the liquid tank.

2. The non-contact level sensor assembly of claim 1, wherein the liquid is transparent to the energy emitted by the non-contact level sensor.

3. The non-contact level sensor assembly of claim 1, wherein the housing is fluidly coupled to the liquid tank.

4. The non-contact level sensor assembly of claim 1, wherein the housing is external to the liquid tank.

5. The non-contact level sensor assembly of claim 1, wherein the housing is partially internal to the liquid tank.

6. The non-contact level sensor assembly of claim 1, wherein a top of the housing with respect to gravity is hermetically sealed.

7. The non-contact level sensor assembly of claim 1, wherein the liquid tank is an electrolyte tank a redox flow battery system.

8. A method, comprising:
emitting energy from a non-contact level sensor of a non-contact level sensor system towards a float of the non-contact level sensor system, the non-contact level sensor system fluidly coupled to a liquid tank;
reflecting and/or scattering energy from the float towards the non-contact level sensor;
receiving the reflected and/or scattered energy at the non-contact level sensor and outputting a signal; and
converting the signal to a liquid amount inside the liquid tank.

9. The method of claim 8, wherein the liquid tank is an electrolyte tank of a redox flow battery system.

10. The method of claim 9, further comprising adjusting the redox flow battery system in response to the converted signal.

11. The method of claim 8, wherein emitting the energy includes emitting acoustic waves or microwaves.

12. The method of claim 8, wherein the float is positioned within a housing of the non-contact level sensor system.

13. The method of claim 8, further comprising averaging the signal for a period of time before outputting the signal.

14. The method of claim 8, wherein the method is repeated continuously during operation of a redox flow battery system.

15. A redox flow battery system, comprising:
an electrolyte tank;
an electrolyte filling the electrolyte tank to an electrolyte level;
a gas head space within the electrolyte tank including a volume of the electrolyte tank above the electrolyte level;
at least one non-contact level sensor system including a housing fluidly coupled to the electrolyte tank; and
wherein the at least one non-contact level sensor system includes a float and a non-contact level sensor.

16. The redox flow battery system of claim 15, wherein the float is floating on a surface of the electrolyte.

17. The redox flow battery system of claim 15, wherein a gas pressure within the housing fluidly coupled to electrolyte chamber is equal to a gas pressure within the electrolyte tank.

18. The redox flow battery system of claim 15, wherein the float is formed of a material opaque and/or reflective to an energy emitted by the non-contact level sensor or a top of the float is coated with the material opaque and/or reflective to the energy emitted by the non-contact level sensor.

19. The redox flow battery system of claim 15, wherein the electrolyte tank is a multi-chambered electrolyte storage tank.

20. The redox flow battery system of claim 19, wherein the at least one non-contact level sensor system includes a first non-contact level sensor assembly configured to output an amount of electrolyte in a first electrolyte chamber of the multi-chambered electrolyte storage tank and a second non-contact level sensor assembly configured to output an amount of electrolyte in a second electrolyte chamber of the multi-chambered electrolyte storage tank.
